(19) United States
(12) Patent Application Publication
(10) Pub. No.: US 2016/0083254 A1
(43) Pub. Date: Mar. 24, 2016

(54) METHOD, DEVICE AND SYSTEM FOR ENRICHMENT OF NF3 GAS

(71) Applicant: OCI COMPANY LTD., Seoul (KR)

(72) Inventors: Dong-Won LIM, Seongnam-si (KR); Jong-Eun SHIN, Seongnam-si (KR); Youn-Joong KIM, Seongnam-si (KR); Hyun-Jun KIM, Seongnam-si (KR); Sang-Yup LEE, Seongnam-si (KR)

(21) Appl. No.: 14/857,423

(22) Filed: Sep. 17, 2015

(30) Foreign Application Priority Data
Sep. 24, 2014 (KR) 10-2014-0127631

(51) Int. Cl. C01B 21/083; B01D 53/22

(52) U.S. Cl. CPC C01B 21/0837; B01D 53/22; B01D 53/226; B01D 53/227; B01D 2053/221

(57) ABSTRACT

Disclosed is a method for enrichment of NF₃ gas, comprising: (a) feeding a gas mixture containing a low concentration of NF₃ gas and impurities; and (b) passing the feed gas mixture through a non-porous membrane module, wherein an enriched NF₃ gas mixture passing through the non-porous membrane module and an unenriched NF₃ gas mixture failing to pass through the non-porous membrane module are separated depending on the differences in the kinetic diameters of the individual gases.

### CROSS-REFERENCE TO RELATED APPLICATIONS

This application claims the benefit of Korean Patent Application No. 10-2014-0127631, filed on Sep. 24, 2014, entitled “METHOD, DEVICE AND SYSTEM FOR ENRICHMENT OF NF3 GAS”, which is hereby incorporated by reference in its entirety into this application.

### BACKGROUND

1. Technical Field

The present invention relates to a method, device and system for enrichment of NF₃ gas using a non-porous membrane module.

2. Description of the Related Art

Nitrogen trifluoride (hereinafter, NF₃) gas is used as a detergent for semiconductor or an etchant for CVD device, etc. With the development of the semiconductor industry, the demands have been increased for NF₃ gas, and it is necessarily required that NF₃ gas used as such should be high-purity in which any impurities are hardly contained.

NF₃ gas mixture can be prepared by various methods. For example, NF₃ gas mixture may be prepared by a method of electrolysis of molten salts of ammonium fluoride, or a method of reaction of a molten ammonium fluoride with fluorine in gas phase, etc. The NF₃ gas mixture prepared by these methods may include impurities, such as N₂, O₂, CO₂, H₂O, CH₄, HF, SF₆, C₂F₆, OF₂, N₂O, N₂F₂, CO, etc.

In conventional methods for removing impurities in the NF₃ gas mixture, purification with an adsorbent has been mainly used, and other methods including cryogenic distillation methods, methods using an absorbing solution, methods using a boiling point, chromatographic separation methods, azeotropic/extractive distillation methods, thermal swing adsorption (TSA) methods are also known.

### BRIEF SUMMARY

An aspect of the present disclosure is to provide a method for enrichment of NF₃ gas, comprising: (a) feeding a gas mixture containing a low concentration of NF₃ gas and impurities; and (b) passing the feed gas mixture through a non-porous membrane module, wherein an enriched NF₃ gas mixture passing through the non-porous membrane module and an unenriched NF₃ gas mixture failing to pass through the non-porous membrane module are separated depending on the differences in the kinetic diameters of the individual gases.

According to some embodiments of the present disclosure, the concentration (w/w) of the NF₃ gas mixture in the feed gas mixture may be in a range of from 0.01% to 1%.

According to some embodiments of the present disclosure, the feed gas mixture may be supplied at a flow rate of 500 ml/min to 5,000 ml/min and at a temperature of between 5° C. and 30° C.

According to some embodiments of the present disclosure, the non-porous membrane module may be kept under pressure of 1 bar to 15 bars.

According to some embodiments of the present disclosure, it can be characterized by satisfying the following equation:

0.0002≦pressure in the non-porous membrane module(bar)/flow rate of the feed gas mixture(ml/min)≦0.002 Equation 1

According to some embodiments of the present disclosure, the non-porous membrane module may be provided with a jacket for maintaining a temperature in the non-porous membrane module.

According to some embodiments of the present disclosure, the non-porous membrane module may have a separation factor of at least 5, and a stage-cut of at most 0.6.

According to some embodiments of the present disclosure, the non-porous membrane module may include a membrane formed of at least one material selected from the group consisting of polyimide, polyamide, polyamide-imide, polyester, polycarbonate, polysulfone, polyether sulfone, polyether ketone, and combinations thereof.

According to some embodiments of the present disclosure, the concentration of the NF₃ gas in the enriched NF₃ gas mixture may be increased by 1.2 times or more compared to the concentration of the NF₃ gas in the feed gas mixture.

According to some embodiments of the present disclosure, the method may further include (c) evaluating the flow rate of the enriched NF₃ gas mixture or the concentration of the NF₃ gas in the enriched NF₃ gas mixture.

According to some embodiments of the present disclosure, the method may further include (d) recovering the enriched NF₃ gas mixture to re-separate and enrich the same.

Another aspect of the present disclosure is to provide a device for enrichment of NF₃ comprising a controller for controlling the supply of a gas mixture containing a low concentration of NF₃ gas and impurities; and a non-porous membrane module for enrichment of NF₃ gas.

According to some embodiments of the present disclosure, the non-porous membrane module may have a separation factor of at least 5 and a stage-cut of at most 0.6.

According to some embodiments of the present disclosure, the non-porous membrane module may include a membrane formed of at least one material selected from the group consisting of polyimide, polyamide, polyamide-imide, polyester, polycarbonate, polysulfone, polyether sulfone, polyether ketone, and combinations thereof.

Yet another aspect of the present disclosure is to provide a system for enrichment of NF₃ gas wherein the devices for enrichment of NF₃ gas are arranged in series or in parallel.

The method for enrichment of NF₃ gas using a non-porous membrane module according to the present disclosure can effectively separate a low concentration of NF₃ gas from impurities and enrich the same to a high concentration, without using a high heat source or a cryogenic energy, which therefore can be used as an etchant for semiconductor or a detergent for CVD device.

### BRIEF DESCRIPTION OF THE DRAWINGS

The above and other aspects, features and advantages of the present disclosure will become apparent from the following description of exemplary embodiments given in conjunction with the accompanying drawings, in which:

FIG. 1 is a schematic cross-sectional view of the device for enrichment of NF₃ gas according to an embodiment of the present disclosure.

### DETAILED DESCRIPTION

Hereinafter, several embodiments of the present invention will be described in detail with reference to the accompanying drawing to such an extent that the present invention can be easily embodied by a person having ordinary skill in the art to which the present invention pertains. The present invention may be implemented in various different forms, and therefore, the present invention is not limited to the illustrated embodiments.

In order to clearly describe the present invention, parts not related to the description are omitted, and like reference numerals designate like constituent elements throughout the specification.

Hereinafter, some embodiments of the present disclosure will be described in detail.

### Method for Enrichment of NF₃ Gas

The present disclosure provides a method for enrichment of NF₃ gas, comprising: (a) feeding a gas mixture containing a low concentration of NF₃ gas and impurities; and (b) passing the feed gas mixture through a non-porous membrane module, wherein an enriched NF₃ gas mixture passing through the non-porous membrane module and an unenriched NF₃ gas mixture failing to pass through the non-porous membrane module are separated depending on the differences in the kinetic diameters of the individual gases.

The method for enrichment of NF₃ gas according to the present disclosure is not to simply remove the impurities from the gas mixture comprising NF₃ gas and the impurities while simply purifying the NF₃ gas, but to separate the impurities from the gas mixture comprising NF₃ gas and the impurities while at the same time enriching the NF₃ gas to a 1.2 times or more highly concentrated NF₃ gas.

Conventionally, the non-porous membrane module has not been used for the enrichment of NF₃ gas.

First, the step (a) is a step of feeding a gas mixture containing a low concentration of NF₃ gas and impurities.

The gas mixture contains a low concentration of NF₃ gas and impurities as an individual gas, wherein the impurities may include N₂, O₂, CO₂, H₂O, CH₄, HF, SF₆, C₂F₆, OF₂, N₂O, N₂F₂ and CO. In particular, the concentration (w/w) of N₂ in the impurities is more than 60%, which constitutes a very high proportion, and so the removal of N₂ is necessary.

The NF₃ gas is a type of semiconductor device manufacturing gas used as an etchant for semiconductor or a detergent for CVD device, and besides NF₃ gas, for example, SF₆ gas, CF₄ gas and the like may be used as a semiconductor device manufacturing gas. However, in the case of SF₆ gas and CF₄ gas, their decomposition efficiencies in the process are as poor as less than 50%, and due to air leakage of unreacted gases, they have major impact on the greenhouse effect (SF₆ (GWP: 24,000), CF₄ (GWP: 6,500)), and so their use as a semiconductor device manufacturing gas is avoided.

On the contrary, the NF₃ gas is excellent in decomposition efficiency in the process as 90% or more, and unreacted gases are less generated, and so it does not have a significant effect on greenhouse effect (NF₃ (GWP: 17,000)), as well as its use as a semiconductor device manufacturing gas is suitable and widely used.

On the other hand, in the case of SF₆ gas, the difference in kinetic diameter between SF₆ and N₂ which occupies a significantly higher proportion in the impurities is about 1.488 Å (SF₆ about 5.128 Å; N₂ about 3.64 Å), while in the case of NF₃ gas, the difference in kinetic diameter between NF₃ and N₂ which occupies a significantly higher proportion in the impurities is about 0.86 Å (NF₆ about 4.5 Å; N₂ about 3.64 Å), and thus great technical difficulties have been encountered in separating them from each other.

Therefore, according to some embodiments of the present disclosure, even though the kinetic diameter differences between the individual gases is nothing but about 0.86 Å, the present technique makes possible the efficient separation and enrichment of NF₃ gas, by way of supplying the gas mixture under optimal conditions and maintaining the non-porous membrane module under optimal conditions.

According to some embodiments, the low-concentration NF₃ gas (w/w) in the gas mixture is preferably in a range of from 0.01% to 1%. When the concentration of NF₃ gas (w/w) is within this range, NF₃ gas can be preferably applied to the non-porous membrane module.

The gas mixture is preferably supplied at a flow rate of 500 ml/min to 5,000 ml/min at a temperature of 5° C. to 30° C., and more preferably at a flow rate of 1,000 ml/min to 5,000 ml/min at a temperature of 10° C. to 25° C., but not limited thereto.

In such embodiments, when the gas mixture is supplied at a temperature lower than the above range, permeability of N₂ becomes low, such that problem occurs in the enrichment of NF₃ gas, while when the gas mixture is supplied at a temperature higher than the above range, problem of lower production efficiency relative to energy cost occurs. The control of the supply temperature may be carried out through a temperature controller.

In addition, when the gas mixture is supplied at a flow rate lower than the above range, permeability of NF₃ gas becomes high, and so recovery rate of NF₃ gas becomes lower, while when the gas mixture is supplied at a flow rate in excess of the above range, the recovery rate of NF₃ gas increases, but permeability of N₂ becomes lower, which leads to the problems of higher equipment and operating costs. The control of the feed rate can be done through a mass flow controller.

Next, the step (b) is a step of passing the feed gas mixture through a non-porous membrane module, where an enriched NF₃ gas mixture passing through the non-porous membrane module and an unenriched NF₃ gas mixture failing to pass through the non-porous membrane module are separated depending on the differences in the kinetic diameters of the individual gases.

The non-porous membrane modules are separated according to the differences in diffusion rates due to the kinetic diameter differences between the individual gases in the feed gas mixture.

As used herein, the term “enriched NF₃ gas mixture” indicates a product as un-permeated, which passes through the non-porous membrane module, and as a result the concentration of NF₃ gas is increased compared to the concentration of NF₃ gas in the feed gas mixture.

Further, as used herein, the term “unenriched NF₃ gas mixture” indicates a by-product as permeated, which fails to pass through the non-porous membrane module, and as a result the concentration of NF₃ gas is reduced compared to the concentration of the NF₃ gas in the feed gas mixture.

According to some embodiments, the non-porous membrane module preferably maintains at a pressure of 1 bar to 15 bars, but not limited thereto. In such embodiments, when the non-porous membrane module maintains at a pressure of less than 1 bar, the permeability of N₂ becomes low and the equipment and operating costs become high, while when the non-porous membrane module maintains at a pressure in excess of 15 bars, the permeability of NF₃ becomes high and the recovery rate of NF₃ becomes low, as well as an equipment for increasing the recovery rate of NF₃ should be installed. The non-porous membrane module can maintain the pressure within the above ranges by further connecting a pressure controller for controlling the pressure in the non-porous membrane module with the non-porous membrane module.

In particular, the method for enrichment of NF₃ gas can satisfy the following equation:

0.0002 pressure in the non-porous membrane module(bar)/flow rate of the feed gas mixture(ml/min)≦0.002 Equation 1

As shown in equation 1, the pressure (bar) in the non-porous membrane module relative to the flow rate (ml/min) of the feed gas mixture may be in a range of 0.0002 to 0.002. When the pressure in the non-porous membrane module relative to the flow rate of the feed gas mixture is less than the above range, the concentration of NF₃ gas in the enriched NF₃ gas mixture becomes too low, while when the pressure in the non-porous membrane module relative to the flow rate of the feed gas mixture exceeds the above range, the concentration of NF₃ gas in the enriched NF₃ gas mixture becomes high, but both the stage-cut and the permeability increase too high, and both the separation factor and the recovery rate become too decreased, and so the permeated amount relative to the enriched amount becomes increased. Therefore, the pressure in the non-porous membrane module relative to the flow rate of the feed gas mixture is preferably maintained within the aforesaid ranges.

For example, when the pressure in the non-porous membrane module (bar) relative to the flow rate of the feed gas mixture (ml/min) is in a range of 0.0002 to 0.002, the stage-cut may be less than or equal to 0.6, and the separation factor may be greater than or equal to 5, which are preferable in the process efficiency and economical point of view.

According to some embodiments, the non-porous membrane module may be provided with a jacket for maintaining the temperature in the non-porous membrane module.

The non-porous membrane module is configured to be able to use permeability difference between the gases in the gas mixture, and the separation factor of the non-porous membrane module is preferably at least 5, but not limited thereto. When the separation factor of the non-porous membrane module is less than 5, it causes a reduced separation efficiency of N₂ and NF₃ gases and higher operating costs in separation and enrichment. Within this range, the separation factor of the non-porous membrane module shows a tendency to decrease with increasing pressure in the non-porous membrane module, and to increase with increasing flow rate of the feed gas mixture.

Specifically, the non-porous membrane module may use non-porous membrane, and preferably include a membrane comprising at least one material selected from the group consisting of polyimide, polyamide, polyamide-imide, polyester, polycarbonate, polysulfone, polyether sulfone, polyether ketone, and combinations thereof. Membrane of polysulfone material is more preferred, but not limited thereto.

The concentration of the NF₃ gas in the enriched NF₃ gas mixture may be increased by at least about 1.2 times compared to the concentration of NF₃ gas in the gas mixture, which allows the low concentration NF₃ gas to be efficiently separated from the impurities and highly concentrated.

According to some embodiments, the present method may further include (c) evaluating the flow rate of the enriched NF₃ gas mixture or the concentration of the NF₃ gas in the enriched NF₃ gas mixture. The determination of the flow rate may be performed by a flow meter, and the determination of the concentration may be carried out by a gas chromatography.

When a first recovery is made, the enriched NF₃ gas mixture that has firstly passed through the non-porous membrane module is firstly recovered, which is then again subjected to a second pass to the non-porous membrane module.

According to some embodiments, the present method may further include (d) recovering the enriched NF₃ gas mixture to separate and enrich the same again. With such recovery and re-separation and enrichment, the final concentration of NF₃ gas in the enriched NF₃ gas mixture may be further increased. In these embodiments, the recovery and re-separation and enrichment may be repeated several times.

Specifically, the step of evaluating the flow rate of the enriched NF₃ gas mixture that has firstly passed through the non-porous membrane module or the concentration of NF₃ gas in the enriched NF₃ gas mixture that has firstly passed through the non-porous membrane module may be precedent for the recovery.

Device and System for Enrichment of NF₃ Gas

The present disclosure further provides a device for enrichment of NF₃ gas, comprising a controller for controlling the supply of a gas mixture containing a low concentration of NF₃ gas and impurities; and a non-porous membrane module for enrichment of NF₃ gas.

The present disclosure further provides a system for enrichment of NF₃ gas wherein the devices for enrichment of NF₃ gas are arranged in series or in parallel.

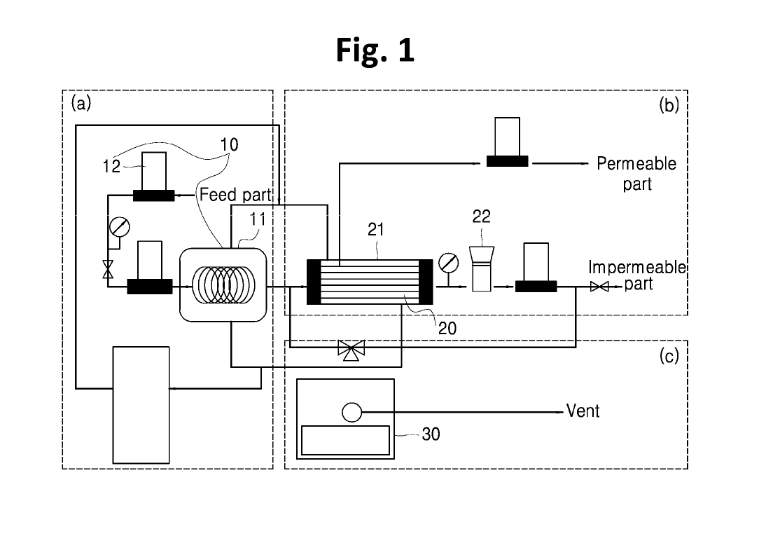

FIG. 1 is a schematic cross-sectional view of the device for enrichment of NF₃ gas according to an embodiment of the present disclosure.

As depicted in FIG. 1, the device for enrichment of NF₃ gas according to an embodiment of the present disclosure includes a controller 10 for controlling the supply of a gas mixture containing a low concentration of NF₃ gas and impurities; and a non-porous membrane module 20 for enrichment of NF₃ gas.

First, the controller 10 serves to control the supply of the gas mixture containing a low concentration NF₃ gas and impurities, wherein the controller 10 may comprise a temperature controller 11 for controlling the supply temperature of the gas mixture or a flow controller 12 for controlling the supply flow rate of the gas mixture.

Specifically, the temperature controller 11 may include a chamber for maintaining a temperature and a coil set at constant temperature within the chamber. In this embodiment, the coil set at constant temperature (50° C. or less) uses electrical energy as a heat source, and is adapted to uniformly maintain the temperature of the gas mixture supplied to the non-porous membrane module 20 or the temperature within the non-porous membrane module 20, around which the gas mixture is permeated. The chamber may automatically control the supply temperature of the gas mixture by surrounding the coil to maintain the temperature of the gas mixture.

The flow controller 12 that can be used includes a mass flow controller (MFC).

In addition to the above controller 10, a flow meter, a pressure gauge, a thermometer and the like for the gas mixture containing a low concentration NF₃ gas and impurities may be further included.

Next, the non-porous membrane module 20 is intended for the separation and enrichment of the NF₃ gas, and the separation factor and the membrane material for the non-porous membrane module 20 are as described above.

The non-porous membrane module 20 may be provided with a jacket 21 for maintaining the temperature in the non-porous membrane module 20. In particular, the jacket 21 is configured to have a double wall surrounding the non-porous membrane module 20, in which a fluid such as water flows through to warm or cool and thereby maintain the temperature in the non-porous membrane module 20.

According to some embodiments, a pressure controller 22 for controlling the pressure in the non-porous membrane module 20 may be further connected to the non-porous membrane module 20. As such, the non-porous membrane module 20 is adapted to be maintained under pressure of 1 bar to 15 bars, such that efficient separation and enrichment of NF₃ gas is possible.

Preferably, the pressure controller 22 may include a back pressure controller (BPR), which can be connected to an outlet of the non-porous membrane module 20 to stabilize the pressure in the non-porous membrane module 20.

In addition to the non-porous membrane module 20, a flow meter, a pressure gauge, a thermometer, and the like for enriched NF₃ gas mixture or NF₃ gas un-enriched gas mixture may be further included.

In addition, a flow meter 30 for evaluating a flow rate of the enriched NF₃ gas mixture or a gas chromatography 30 for evaluating a concentration of the NF₃ gas in the enriched NF₃ gas mixture may be further included.

The flow meter 30 may be used to evaluate the flow rate of the enriched NF₃ gas mixture, and includes, but is not limited to, a mass flow meter (MFM). The mass flow meter is intended to detect the mass of a fluid passing through a pipe per unit time, and is advantageously not affected by gravity, pressure, temperature, etc.

The flow meter may be classified with two types as follows: (i) a direct type flow meter: a calorimetric flow meter for comparing the mass (density) and the flow rate of a fluid with temperature rise of the fluid, a pressure differential flow meter using a combination of orifice and metering pump, and a momentum flow meter for measuring torque with a combination of impeller and turbine blade; and (ii) an indirect type flow meter configured to have various kinds of structures with a combination of flow meter and densitometer.

In the present disclosure, among the various mass flow meter, quadruple mass spectrometer (QMS) capable of evaluating a real time flow rate may be used.

The gas chromatography 30 may be used to evaluate the concentration of the NF₃ gas in the enriched NF₃ gas mixture. The gas chromatography 30 will spill a number of gas mixture in a tube in which an appropriate amount of charges is filled, to allow each component to be separated to smear out.

As described above, the method for enrichment of NF₃ gas using the non-porous membrane module according to the present disclosure can effectively separate a low concentration NF₃ gas from the impurities and concentrate it to a high concentration without using a high heat source or a cryogenic energy, whereby the resulting NF₃ gas can be used as an etchant for semiconductor device or a detergent for CVD device.

Hereinafter, preferred examples will be described to exemplary illustrate the present disclosure. However, the following examples are merely provided to facilitate understanding of the present disclosure, but should not be construed to limit the present disclosure.

### Example 1

Gas mixture comprising a low concentration of NF₃ gas and impurities comprising HF, N₂F₂, OF₂, N₂O, CO₂, SO₂F₂, and water was fed at 1,000 ml/min at a temperature of 25° C. At this time, the concentration of the NF₃ gas (w/w) in the feed gas mixture was 0.61%. The feed gas mixture was subjected to pass through a non-porous membrane module 20 (A company, MF-1512A) under pressure of 1.5 bars, wherein enriched NF₃ gas mixture was relatively non-permeable, while NF₃ gas un-enriched gas mixture failing to pass through the non-porous membrane module 20 was relatively permeable.

The flow rates of enriched NF₃ gas mixture (impermeable part) and NF₃ gas un-enriched gas mixture (permeable part), and the concentrations of the NF₃ gases in each of the gas mixtures were evaluated by QMS (Quadrople mass spectrometer) (H Company, HPR-20) and gas chromatography (A company, CP-4900). The stage-cut (θₚ), permeability (GPU), separation factor (II) and recovery rate were calculated by the following formulae 2 to 5, and the results are shown in Table 1 below:

Stage-cut(θₚ)=Qₚ/Q_{f} Formula 2

wherein Qₚ indicates a flow rate (ml/min) of the gas mixture passing through the non-porous membrane module 20, and Q_{f} indicates a flow rate (ml/min) of the feed gas mixture;

Permeability(GPU,cm³(STP)/cm²·sec·cmHg)=V(STP)/A(Δp)t Formula 3

wherein V indicates a permeated volume as calculated, A indicates an effective area, Δp indicates a pressure difference, and t indicates a permeable time;

Separation factor(II)=[C_{N2}/C_{NF3}]ₚ/[C_{N2}/C_{NF3}]_{f} Formula 4

wherein C_{N2} indicates a concentration of N₂ in the gas mixture, C_{NF3} indicates a concentration of NF₃ component in the gas mixture, p indicates permeable part, and f indicates a feed part; and

Recovery rate(%)=[Q*C_{NF3}]R/[Q*C_{NF3}]_{f} Formula 5

wherein Q indicates a flow rate (ml/min) of the gas mixture, C_{NF3} indicates a concentration of NF₃ component in the gas mixture, R indicates a non-permeable part, and f indicates a feed part.

### Examples 2-7

NF₃ gas was separated and concentrated in the same manner as Example 1, except that the flow rate of the feed gas mixture or the pressure in the non-porous membrane module 20 was modified as shown in Table 1 below.

### Examples 8-10

NF₃ gas was firstly separated and concentrated in the same manner as Example 1, except that the concentration of NF₃ gas (w/w) in the feed gas mixture was 0.67% (Example 8). Then, the enriched NF₃ gas mixture passing through the non-porous membrane module 20 was firstly recovered, and again subjected to pass through the non-porous membrane module 20 as feed gas mixture to thereby secondarily separate and concentrate the NF₃ gas (Example 9). Then, the gas mixture permeated through the non-porous membrane module 20 was secondarily recovered, and again subjected to pass through the non-porous membrane module 20 as feed gas mixture to thereby thirdly separate and concentrate the NF₃ gas (Example 10).

TABLE 1

| | Gas mixture | | | Gas mixture | | Gas mixture | | | | | |
|---|---|---|---|---|---|---|---|---|---|---|---|
| | (feed part) | | | (permeable part) | | (impermeable part) | | | | | |
| | | Concen- | | | Concen- | | Concen- | | | | |
| | Flow | tration | | Flow | tration | Flow | tration | Stage- | Perme- | Separation | Recovery |
| | rate | of NF₃ | | rate | of NF₃ | rate | of NF3 | cut | ability | factor | rate |
| | (ml/min) | gas (%) | Pressure | (ml/min) | gas (%) | (ml/min) | gas (%) | (θₚ) | (GPU) | (II) | (%) |
| Example 1 | 1,000 | 0.61 | 1.5 | 390 | 0.11 | 610 | 0.87 | 0.39 | 4.80 | 5.5734 | 91.64 |
| Example 2 | 1,000 | 0.61 | 2.0 | 537 | 0.11 | 463 | 1.05 | 0.54 | 4.95 | 5.5734 | 86.64 |
| Example 3 | 1,000 | 0.61 | 2.5 | 705 | 0.13 | 295 | 1.46 | 0.70 | 5.21 | 4.7150 | 82.6 |
| Example 4 | 1,000 | 0.61 | 3.0 | 885 | 0.17 | 115 | 2.46 | 0.89 | 5.49 | 3.6041 | 69.73 |
| Example 5 | 1,500 | 0.61 | 2.5 | 641 | 0.10 | 859 | 0.94 | 0.43 | 4.78 | 6.1313 | 93.48 |
| Example 6 | 2,000 | 0.61 | 2.5 | 630 | 0.09 | 1,370 | 0.82 | 0.32 | 4.71 | 6.8132 | 95.44 |
| Example 7 | 2,500 | 0.61 | 2.5 | 632 | 0.09 | 1,868 | 0.77 | 0.25 | 4.72 | 6.8132 | 96.65 |
| Example 8 | 2,000 | 0.67 | 2.5 | 630 | 0.10 | 1,370 | 0.93 | 0.32 | 5.21 | 6.813 | 95.35 |
| (1^{st}) | | | | | | | | | | | |
| Example 9 | 2,000 | 0.93 | 2.5 | 630 | 0.14 | 1,370 | 1.30 | 0.32 | 5.21 | 6.813 | 90.91 |
| (2^{nd}) | | | | | | | | | | | |
| Example 10 | 2,000 | 1.30 | 2.5 | 630 | 0.20 | 1,370 | 1.81 | 0.32 | 5.21 | 6.813 | 86.66 |
| (3^{rd}) | | | | | | | | | | | |

Referring to Table 1, in accordance with the method for enrichment of NF₃ gas according to Examples 1 to 7, it was found that the use of the non-porous membrane module can effectively separate a low concentration NF₃ gas from the impurities and concentrate it to a high concentration without using a high heat source or a cryogenic energy. Further, it was found that the concentration of NF₃ gas in the gas mixture (impermeable part) increased at least about 1.26 times compared to that of NF₃ gas in the gas mixture (feed part).

Specifically, as shown in Examples 1 to 4, when the pressures in the non-porous membrane module 20 were changed from 1.5 to 3.0 bars while fixing the flow rate of the gas mixture (feed part) at 1,000 ml/min, the concentration of NF₃ gas in the gas mixture (impermeable part) showed a tendency to increase with the pressure increase, and the stage-cut (θₚ) and the permeability (GPU) was increased. Meanwhile, the separation factor (II) and the recovery rate were found to show a tendency to decrease.

At this time, as the stage-cut (θₚ) and permeability (GPU) values are higher, and the separation factor (II) and recovery rate are lower, the amount of permeation is higher compared to the amount of separation and enrichment, which is disadvantageous in the process efficiency and the economical point of view.

As a result, it was found that when the pressure in the non-porous membrane module 20 compared to the flow rate of the gas mixture (feed part) as in Examples 3 and 4 is too high, the concentration of NF₃ in the gas mixture (impermeable part) is increased, but the stage-cut (θₚ) and the permeability (GPU) are too increased, and the separation factor (II) and the recovery rate are too reduced, such that the permeated amount compared to the separated and concentrated amount disadvantageously is increased.

Thus, in the present method for enrichment of NF₃ gas, it is particularly preferred to properly adjust the pressure in the non-porous membrane module 20 compared to the flow rate of the gas mixture (feed part), such that the stage-cut (θₚ) is 0.6 or less, the separation factor (II) of the non-porous membrane module 20 is 5 or more.

In addition, as shown in Examples 5 to 7, it could be found that when the flow rate of the of the gas mixture (feed part) changes from 1,500 ml/min to 2,500 ml/min, while the pressure in the non-porous membrane module 20 is fixed at the pressure of 2.5 bars, as the flow rate becomes increased, the concentration of NF₃ gas in the gas mixture (impermeable part) is slightly lower, but the permeability (GPU) is decreased, and the separation factor (II) and the recovery rate are increased.

Further, in accordance with the method for enrichment of NF₃ gas according to Examples 8 to 10, it may further include recovering the gas mixture permeated through the non-porous membrane modules 20 arranged in series, whereby it was found that the concentration of NF₃ gas in the gas mixture (impermeable part) could be increased with no changes in the stage-cut (θₚ), the permeability (GPU) and the separation factor (II).

Although some embodiments have been provided to illustrate the present invention, it will be apparent to those skilled in the art that the embodiments are given by way of illustration, and that various modifications and equivalent embodiments can be made without departing from the spirit and scope of the present invention. Accordingly, the scope of the present invention should be limited only by the accompanying claims and equivalents thereof.

What is claimed is:

1. A method for enrichment of NF₃ gas, comprising: (a) feeding a gas mixture containing a low concentration of NF₃ gas and impurities; and (b) passing the feed gas mixture through a non-porous membrane module, wherein an enriched NF₃ gas mixture passing through the non-porous membrane module and an unenriched NF₃ gas mixture failing to pass through the non-porous membrane module are separated depending on the differences in the kinetic diameters of the individual gases.

2. The method according to claim 1, wherein the concentration of the NF₃ gas mixture (w/w) in the feed gas mixture is in a range of from 0.01% to 1%.

3. The method according to claim 1, wherein the feed gas mixture is supplied at a flow rate of 500 ml/min to 5,000 ml/min and at a temperature of between 5° C. and 30° C.

4. The method according to claim 1, wherein the non-porous membrane module is kept under a pressure of 1 bar to 15 bars.

5. The method according to claim 1, which satisfies the following equation:
0.0002 pressure in the non-porous membrane module(bar)/flow rate of the feed gas mixture(ml/min)≦0.002 Equation 1

6. The method according to claim 1, wherein the non-porous membrane module is provided with a jacket for maintaining a temperature in the non-porous membrane module.

7. The method according to claim 1, wherein the non-porous membrane module has a separation factor of at least 5 and a stage-cut of at most 0.6.

8. The method according to claim 1, wherein the non-porous membrane module comprises a membrane formed of at least one material selected from the group consisting of polyimide, polyamide, polyamide-imide, polyester, polycarbonate, polysulfone, polyether sulfone, polyether ketone, and combinations thereof.

9. The method according to claim 1, wherein the concentration of the NF₃ gas in the enriched NF₃ gas mixture is increased by 1.2 times or more compared to the concentration of the NF₃ gas in the feed gas mixture.

10. The method according to claim 1, further comprising (c) evaluating the flow rate of the enriched NF₃ gas mixture or the concentration of the NF₃ gas in the enriched NF₃ gas mixture.

11. The method according to claim 1, further comprising (d) recovering the enriched NF₃ gas mixture to re-enrich the same.

12. A device for enrichment of NF₃ comprising a controller for controlling the supply of a gas mixture containing a low concentration of NF₃ gas and impurities; and a non-porous membrane module for enrichment of NF₃ gas.

13. The device according to claim 12, wherein the non-porous membrane module has a separation factor of at least 5 and a stage-cut of at most 0.6.

14. The device according to claim 12, wherein the non-porous membrane module comprises a membrane formed of at least one material selected from the group consisting of polyimide, polyamide, polyamide-imide, polyester, polycarbonate, polysulfone, polyether sulfone, polyether ketone, and combinations thereof.

15. A system for enrichment of NF₃ gas wherein the devices for enrichment of NF₃ gas according to claim 12 are arranged in series or in parallel.
